(19) United States
(12) Patent Application Publication
(10) Pub. No.: US 2010/0314568 A1
(43) Pub. Date: Dec. 16, 2010

(54) Solenoid coil

(75) Inventor: Charles R. Schenk, Edwardsburg, MI (US)

Correspondence Address: BAKER & DANIELS LLP, 202 South Michigan Street, Suite 1400, South Bend, IN, 46601, US

(73) Assignee: South Bend Controls, Inc., South Bend, IN (US)

(21) Appl. No.: 12/799,424

(22) Filed: Apr. 23, 2010

Related U.S. Application Data
(60) Provisional application No. 61/187,101, filed on Jun. 15, 2009.

(51) Int. Cl. F16K 31/02; H01F 7/16

(52) U.S. Cl. 251/129.15; 335/255

(57) ABSTRACT

In one embodiment of the invention, a solenoid is provided that is energizable by an electric current and includes: a pole piece, which is configured from a magnetizable pole material; an armature, which is movable when an electric current is passed through the solenoid; and an electromagnetic coil. A current passes through the coil when the solenoid is energized; the coil includes a central opening, wherein the pole piece is at least partially located. The diameter of the central opening may be less in a mid region than at upper and lower ends of the coil. At least one of either the upper or lower inside ends of the central opening of the coil may be beveled or contoured with a radius. The magnetic flux generated when the coil is energized has an enhanced flow path reducing the saturation in the transitional area at the upper and lower inside ends of the central opening as compared to a standard coil.

This application claims the benefit of U.S. Provisional Patent Application Ser. No. 61/187,101 filed Jun. 15, 2009, the complete disclosure of which is hereby expressly incorporated by reference.

### BACKGROUND OF THE INVENTION

This invention relates in general to solenoid valves, both to the proportional and on/off variety, and in particular, to a coil design for solenoid valves that has an enhanced magnetic flux path.

Coils of the type related to this invention are typically attached to valve elements, which are actuated by the movement of an armature in relation to a static pole piece. Increases in the force between the pole piece and the armature are created by the induction of magnetic flux through a circuit including the pole piece, armature, shell and core of the solenoid valve.

In one type of known conventional solenoid operated valve, a plunger of magnetic material is slidable within the solenoid. A spring or other biasing means urges the plunger into contact with a valve seat. When no current is applied to the solenoid, the valve is maintained closed by the spring. When current flows and the solenoid is energized, a magnetic force acts against the spring to move the plunger away from the valve seat. When the magnetic force exceeds the force of the spring, the plunger moves out of contact with the valve seat into remote position in which the valve is fully opened. A valve of this type has two basic positions, open and closed.

A proportional valve is another type of valve in which the flow of fluid varies in proportion to the current applied to the coil in the solenoid. Such a valve may be desirable for applications in which a gradual variation in flow is preferable to an abrupt change between on and off conditions. Many designs have been proposed for proportional valves. An example of a known proportional valve is shown in U.S. Pat. No. 4,463,332 (the '332 patent) to Everett, incorporated in its entirety herein by reference. The proportional valve in the '332 patent includes a solenoid having an electromagnetic coil and a pole piece. The pole piece is located within the electromagnetic coil, and an armature is located near the pole piece and separated therefrom by a core gap. The pole piece is mounted in the solenoid with a threaded engagement, which can be adjusted to adjust the core gap. The armature is held in place by an armature retainer, and a pair of flat springs are held between the armature retainer and the armature. The solenoid in the '332 patent also includes an annular permanent magnet surrounding the coil to create a field of predetermined flux density in the pole piece. The solenoid assembly in the '332 patent is shown coupled to a valve assembly which utilizes a ball valve.

U.S. Pat. No. 4,767,097 to Everett et al., incorporated in its entirety herein by reference, discloses a proportional valve somewhat similar to that of the '332 patent but which utilizes a different ball valve assembly and housing.

U.S. Pat. No. 6,974,117 B2 to Dzialakiewicz et al., incorporated in its entirety herein by reference, discloses a proportional valve with proportional control, wherein the pole piece and armature define a gap that changes in proportion to the amount of current flowing through the electromagnetic coil. The armature has a pair of shoulders with different diameters and springs of different diameters bearing against the respective shoulders.

### SUMMARY OF THE INVENTION

In one embodiment of the invention, a solenoid is provided that is energizable by an electric current and includes: a pole piece, which is configured from a magnetizable pole material; an armature, which is movable when an electric current is passed through the solenoid; and an electromagnetic coil. A current passes through the coil when the solenoid is energized. The coil includes a central opening, and the pole piece is at least partially located in the central opening. The diameter of the coil in a mid region of the central opening is less than at the upper and lower ends thereof.

At the upper and lower ends of the central opening, the coil is contoured so that the inside diameter of the coil is greater at the upper and lower ends of the central opening. The coil may be beveled adjacent at least one of the upper or lower ends of the central opening, and the coil may be beveled at both of the upper and lower ends of the central opening.

The coil may be contoured with a radius at the upper and/or lower ends of the central opening. The magnetic flux generated when the coil is energized has an enhanced flow path reducing the saturation in the transitional area at the upper and lower inside ends of the coil as compared to a standard coil. Improvements from 0.5% to 50% in the magnetic flux path as calculated by the height of the coil relative to the length of the bevel may be realized.

In another embodiment of the invention, a method for enhancing the magnetic flux path in a solenoid may include the steps of: providing a solenoid having a pole piece of magnetizable material, an armature movable relative to the pole piece when an electric current is passed through the solenoid, an electromagnetic coil configured to receive a current passing therethrough, the coil having an outer diameter and a varying inner diameter along a central opening wherein the inner diameter is greater at upper and lower ends of the central opening than in a mid region thereof; energizing the solenoid with an electric current; and creating a magnetic flux path through the coil, the pole piece and the armature.

The solenoid has an enhanced magnetic flux path with magnetic flux lines that are pinched less at the upper and lower ends of the central opening than in a standard coil having right-angled corners at the upper and lower ends of the central opening.

The coil may be beveled along at least one of either the upper or lower ends of the central opening, and the coil can be beveled along both the upper and lower ends of the central opening. The coil may also be contoured with a radius along at least one of the upper and lower ends of the central opening. The area of increased diameter of the central opening may extend from 0.5% to 50% of the length of the central opening.

The solenoid may also include a core, wherein at least a portion of the core extends into the central opening between the coil and the armature. A coil of a given size and material configured in accordance with the invention has a stronger pull on the armature for a given electric current than a standard coil having right-angled corners.

In another embodiment of the invention, a valve apparatus is provided that includes: a housing; a valve body; an inlet port and an outlet port; a solenoid having an electromagnetic coil; a pole piece of magnetized material; an armature movable relative to the pole piece; and an electromagnetic coil having a central opening and a configuration that provides a varying diameter along the central opening.

The central opening has an upper end and a lower end, and the coil may be contoured with a bevel or radius on at least one of the upper or lower ends of the central opening.

The coil may be contoured with a bevel or radius along both the upper and lower ends of the central opening.

The valve apparatus can include a core, wherein at least a portion of the core extends into the central opening between the coil and the armature.

The diameter is less in a mid region of the central opening than in an area of increased diameter of the central opening that can extend from 0.5% to 50% of the length of the central opening.

In yet another embodiment of the invention, a solenoid that is energizable by an electric current is provided that includes: a housing; a pole piece, which is configured from a magnetizable pole material; an armature, which is movable when an electric current is passed through the solenoid; and an electromagnetic coil configured to receive the electric current passing through the coil when the solenoid is energized, the coil having a generally cylindrical configuration with a top end, a bottom end, an annular outer end, and a central opening. A portion of the coil extending along the central opening is generally parallel to the annular outer end, and another portion of the coil along the central opening extends in a non-parallel orientation to the annular outer end. The coil can be contoured with at least one bevel or radius along the central opening.

### BRIEF DESCRIPTION OF THE DRAWINGS

The above-mentioned and other features and objects of this invention and the manner of obtaining them will become more apparent, and the invention itself will be better understood by reference to the following description of embodiments of the present invention taken in conjunction with the accompanying drawings, wherein:

FIG. 1 is a cross-sectional view of a standard coil in a solenoid;

FIG. 2 is a cross-sectional view of one embodiment of the subject invention showing a solenoid and coil;

FIG. 3 is a cross-sectional perspective view of a solenoid having a coil in accordance with an embodiment of the subject invention;

FIG. 3A is an enlarged view of the coil of FIG. 3 in the area shown; and

FIG. 4 is a cross-sectional view of another embodiment of the subject invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purpose of promoting an understanding of the principles of the invention, reference will now be made to the embodiments illustrated in the drawings, which are described below. It will nevertheless be understood that no limitation of the scope of the invention is thereby intended. The invention includes any alterations and further modifications in the illustrated devices and described methods and further applications of the principles of the invention, which would normally occur to one skilled in the art to which the invention relates.

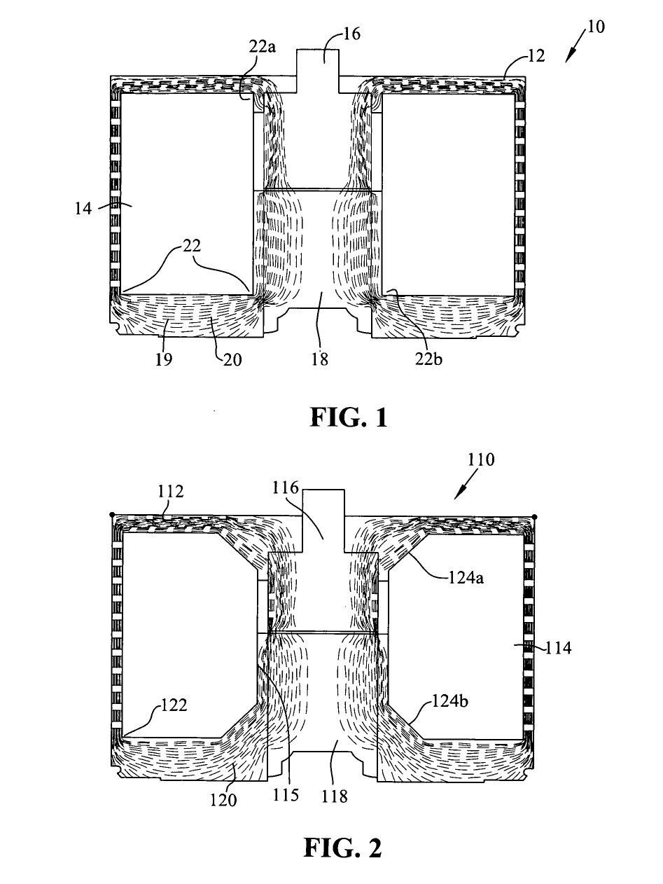

Referring to FIG. 1, a standard or traditional solenoid is shown, generally indicated as 10. Solenoid 10 includes a shell or housing 12, a coiled winding or coil 14, a pole piece 16, a movable armature 18, and a core 19. The solenoid components consist of standard materials and design known in the art. Also shown in the cross-section of FIG. 1 are typical magnetic flux lines 20 that are created when coil 14 is energized by an electric current.

As can be seen, coil 14 has a generally square or rectangular cross-section with right-angled corners 22. This design creates a maximum volume for the windings in a given space of the solenoid housing 12; however, the magnetic circuit is limited as magnetic saturation points are created in the transitional areas near the top and bottom inside diameter corners 22a and 22a, respectively, of solenoid 10. The saturation points act as pinch points that affect and restrict the magnetic flow through the coil and into pole piece 16 and armature 18. Accordingly, the saturation point reduces the efficiency of the solenoid and magnetic flux path through pole piece 16 and armature 18.

Now referring to FIG. 2, one embodiment of a solenoid in accordance with the subject invention is shown, generally indicated as 110. Solenoid 110 includes a shell or housing 112, a contoured coil winding or coil 114, a pole piece 116, and an armature 118. Materials used for solenoid 110 are similar to those in a standard solenoid and known in the art. When solenoid 110 is energized with an electric current, magnetic flux lines 120 are created therein. Magnetic flux lines 120 differ from magnetic flux lines 20 in standard solenoid 10 in that transitional areas at the top and bottom of the inside diameter areas of coil 114 are not saturated. This is a result of the contoured cross-section of coil 114. In this embodiment, the contoured cross-section has right-angled corners on the outside diameter of the coil; however, coil 114 includes a central opening 115 having a varying diameter at the top and bottom of the central opening 115. Coil 114 has beveled corners 124a, 124b, respectively, so that the diameter of opening 115 is smaller in a mid or central area/region than at the beveled areas. As is evident in FIG. 2, magnetic flux lines are improved in coil 110 with increased magnetic flux in pole piece 116 and armature 118. The reduced saturation in the corner or transitional area allows for a dramatic increase in the force output potential for a given envelope of solenoid.

The percentage of the beveled magnetic path is directly related to the increase in attraction force over the traditional coil design. Improvements in the magnetic flux path from 0.5% to 50% with the beveled design have been shown as calculated by the height of the coil to the length of the bevel. Please note that alternate configurations utilizing radii, steps and non-symmetric additions of the core/shell material may also be used with the subject invention.

In one example, a traditional coil produces 3.8 lb f/16.4N as compared to a solenoid using the contoured coil of the subject invention with the same shell or housing size that provides 7.2 lb f/31.9N.

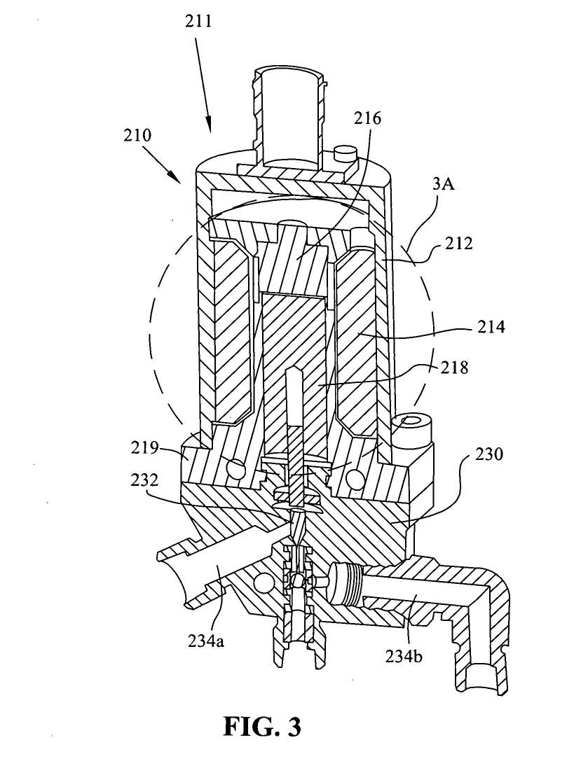

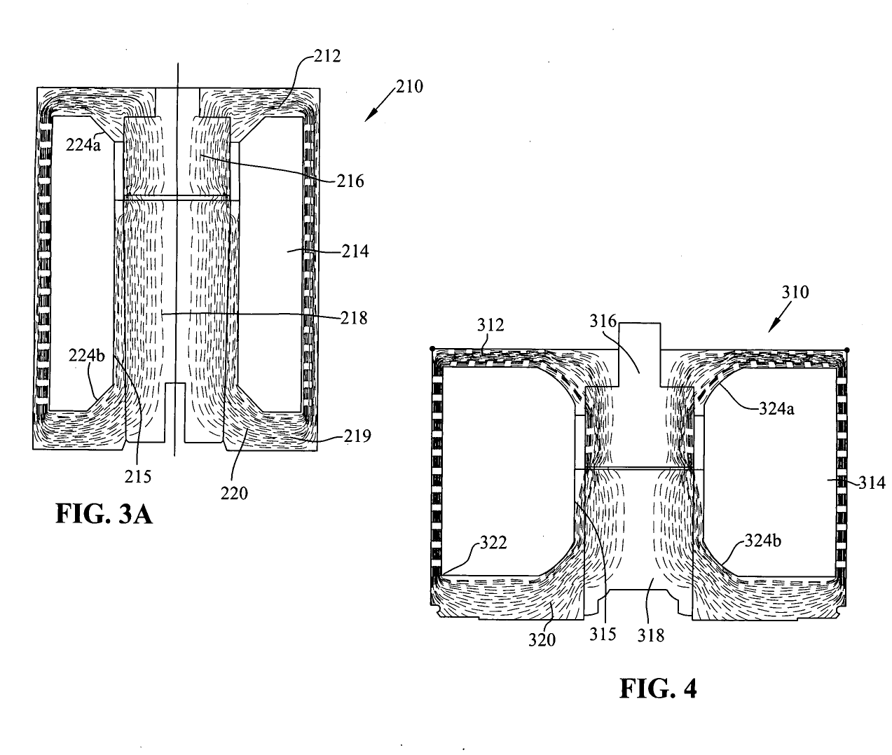

Now referring to FIGS. 3 and 3A, another solenoid in accordance with the subject invention is shown, generally indicated as 210. Solenoid 210 is shown mounted in a valve apparatus, generally indicated as 211. Valve apparatus 211 and solenoid 210 include a shell or housing 212 for the solenoid, a coil 214, a central opening 215 in coil 214, a pole piece 216, an armature 218, and a core 219. In addition, valve 211 includes a valve body 230, a valve stem 232, and ports 234a, 234b. Valve 211 is of a known design and of known materials, and valve stem 232 is attached and mounted to armature 218 and biased by a spring to open and close a valve to allow/permit or prevent exchange of fluids between ports 234a and 234b as is known when the coil is energized/de-energized, respectively.

Referring to FIG. 3A, when solenoid 210 is energized, magnetic flux lines 220 are produced in the solenoid and as the contoured cross-section includes beveled top and bottom inside corners 224a and 224b, respectively, the magnetic flux does not become saturated in this transitional region.

Now referring to FIG. 4, another embodiment of a solenoid in accordance with subject invention is shown, generally indicated as 310. Solenoid 310 includes a shell or housing 312, a contoured coil winding or coil 314, a pole piece 316, and an armature 318. When solenoid 310 is energized with an electric current, magnetic flux lines 320 are created therein. In this embodiment, coil 314 has right-angled corners on the outside diameter of the coils; however, coil 114 includes a central opening 115, wherein the diameter of the central opening is greater at the top and bottom thereof. The varying diameter is attributed to radii being formed on the coil at the top and bottom of central opening 315. Coil 314 functions in a manner similar to coil 114.

While the invention has been taught with specific reference to the above embodiments, one skilled in the art would recognize that changes can be made in form and detail without departing from the spirit and scope of the invention. For instance, as mentioned above, instead of bevels in the corners, a curved design or other alternate design may be used to reduce the saturation in the inside diameter upper and lower corners. In addition, materials of the shell or core may be altered.

The described embodiments are, therefore, to be considered in all respects only as illustrative and not restrictive, and the invention is limited only as claimed and equivalents thereof.

1. A solenoid that is energizable by an electric current, including:
a housing;
a pole piece, which is configured from a magnetizable pole material;
an armature, which is movable when an electric current is passed through the solenoid; and
an electromagnetic coil configured to receive the electric current passing through the coil when the solenoid is energized, said coil including a central opening, and said pole piece is at least partially located in said opening, and the inner diameter of the coil along the central opening is less in a mid region of the central opening than at the upper and lower ends thereof.

2. The solenoid as set forth in claim 1, wherein said coil is contoured at said upper and lower ends of said central opening so as to increase the inside diameter of the coil where contoured.

3. The solenoid as set forth in claim 2, wherein the coil is beveled adjacent at least one of the upper and lower ends of the central opening.

4. The solenoid as set forth in claim 3, wherein the coil is beveled at both the upper and lower ends of the central opening.

5. The solenoid as set forth in claim 2, wherein the coil is contoured with a radius at the upper and lower ends of the central opening.

6. The solenoid as set forth in claim 1, wherein the magnetic flux generated when said coil is energized has enhanced flow path reducing the saturation in the transitional area at the upper and lower inside ends of the central opening as compared to a standard coil.

7. The solenoid as set forth in claim 4, including improvements from 0.5% to 50% in the magnetic flux path as calculated by the height of the coil relative to the length of the bevel.

8. A method for enhancing the magnetic flux path in a solenoid, including the steps of:
providing a solenoid having a pole piece of magnetizable material, an armature movable relative to the pole piece when an electric current is passed through the solenoid, an electromagnetic coil configured to receive a current passing therethrough, the coil having an outer diameter and a varying inner diameter along a central opening, wherein the inner diameter is greater at upper and lower ends of the central opening than in a mid region thereof;
energizing the solenoid with an electric current; and
creating a magnetic flux path through the coil, the pole piece and the armature.

9. The method of providing a solenoid with an enhanced magnetic flux path as set forth in claim 8, wherein the magnetic flux lines are pinched less at the upper and lower ends of the central opening than in a standard coil having right-angled corners at the upper and lower ends of the central opening.

10. The method of providing a solenoid with an enhanced magnetic flux path as set forth in claim 8, wherein the coil is beveled along at least one of either the upper or lower ends of the central opening.

11. The method of providing a solenoid with an enhanced magnetic flux path as set forth in claim 10, wherein the coil is beveled along both the upper and lower ends of the central opening.

12. The method of providing a solenoid with an enhanced magnetic flux path as set forth in claim 8, wherein the coil is contoured with a radius along at least one of the upper and lower ends of the central opening.

13. The method of providing a solenoid with an enhanced magnetic flux path as set forth in claim 8, wherein the area of increased diameter of the central opening extends from 0.5% to 50% of the length of the central opening.

14. The method of providing a solenoid with an enhanced magnetic flux path as set forth in claim 8, wherein the solenoid includes a core, at least a portion of the core extending into the central opening between said coil and said armature.

15. The method of providing a solenoid with an enhanced magnetic flux path as set forth in claim 8, wherein a coil of a given size and material provides a stronger pull on the armature for a given electric current than a standard coil having right-angled corners.

16. A valve apparatus, including:
a housing;
a valve body;
an inlet and an outlet port;
a solenoid having an electromagnetic coil;
a pole piece of magnetized material;
an armature movable relative to the pole piece; and
an electromagnetic coil having a central opening and a configuration that provides a varying diameter along the central opening.

17. The valve apparatus of claim 16, wherein the central opening has an upper end and a lower end, and the coil is contoured with a bevel or radius on at least one of the upper or lower ends of the central opening.

18. The valve apparatus as set forth in claim 17, wherein the coil is contoured with a bevel or radius along both the upper and lower ends of the central opening.

19. The valve apparatus as set forth in claim 16, further including a core, at least a portion of the core extending into the central opening between said coil and said armature.

20. The valve apparatus as set forth in claim 16, wherein the diameter is less in a mid region of the central opening than in an area of increased diameter of the central opening that extends from 0.5% to 50% of the length of the central opening.

21. A solenoid that is energizable by an electric current, including:
a housing;
a pole piece, which is configured from a magnetized pole material;
an armature, which is movable when an electric current is passed through the solenoid; and
an electromagnetic coil configured to receive the electric current passing through the coil when the solenoid is energized, the coil having a generally cylindrical configuration with a top end, a bottom end, an annular outer end, and a central opening, wherein a portion of the coil extending along the central opening is generally parallel to the annular outer end, and another portion of the coil along the central opening extends in a non-parallel orientation to the annular outer end.

22. The solenoid as set forth in the claim 21, wherein the coil is contoured with at least one bevel or radius along the central opening.
